(19) United States
(12) Patent Application Publication
(10) Pub. No.: US 2003/0196896 A1
(43) Pub. Date: Oct. 23, 2003

(54) Method and apparatus for screening flowable separation media for electrophoresis and related applications

(76) Inventors: Thomas Harding McWaid, Fremont, CA (US); Oleg Kolosov, San Jose, CA (US); Gerrit Klaerner, San Jose, CA (US); Miroslav Petro, San Jose, CA (US); Son Hoai Nguyen, Santa Clara, CA (US); Sigrid Kuebler, Sunnyvale, CA (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/124,102

(22) Filed: Apr. 17, 2002

(51) Int. Cl. G01N 27/26; G01N 27/447

(52) U.S. Cl. 204/455; 204/451; 204/452; 204/453; 204/454; 204/601; 204/603; 204/604; 204/605

(57) ABSTRACT

A method and apparatus are disclosed for screening separation media for performance in capillary electrophoresis. In one aspect the invention comprises concurrently loading a plurality of capillaries from one corresponding end of each with a respective plurality of separation media, adding a sample to each capillary, advancing the samples through the capillaries under an applied electric field, measuring a property of the samples or components thereof as they advance through the capillaries, and using the measured properties to identify one or more preferred sets of separation media. At least one of the steps of loading or advancing are carried out simultaneously over the plurality of capillaries.

### BACKGROUND OF THE INVENTION

The present invention relates generally to migration-based separation techniques such as electrophoresis, chromatography and related techniques in combinatorial chemistry techniques. More specifically, the invention relates to the specialized separation technique referred to as capillary electrophoresis (“CE”) and chromatography, and the invention most particularly relates to screening methods and instruments for identifying preferred candidate materials for capillary gel electrophoresis separation media.

Capillary electrophoresis has become a preferred and to some extent standardized method of separating mixtures of molecules of biochemical importance such as proteins and nucleic acid polymers, and particularly deoxyribonucleic acid polymers, i.e., DNA.

In particular, information contained in DNA is contained in the sequence of the four basic building blocks (“bases”) that combine in a variety of sequences to form a DNA molecule. Because DNA molecules are so large, they are typically identified and “sequenced” by forming smaller fragments, and then identifying the make up of those fragments. The techniques for breaking up DNA into such fragments are well understood in the art and will not be repeated in detail herein other than to note that the Sanger method of generating randomly terminated DNA fragments in the presence of enzymes is a common method of such separation.

Once the DNA is separated into manageably-sized fragments, however, these fragments still need to be identified, and are typically separated from one another for such identification purposes. Historically, such separation has been carried out using various chromatography methods.

Because biological samples, particularly samples that contain DNA are very small, the methods used to analyze them must work consistently, precisely and accurately with such small volumes. In addition to its other advantages, because capillary electrophoresis uses small diameter (e.g. 25-100 microns (μm)) capillaries, it is an appropriate and useful technique for small samples. Capillary electrophoresis has other advantages such as its superior ability to dissipate Joule heat. Capillary electrophoresis is also attractive for automated techniques because the nature of the capillary structure potentially permits automating the various steps such as loading the sample, detecting properties of the sample and reloading or replenishing the separation media.

The term “separation medium” (or “media”) will be used herein to describe the contents of CE capillaries. Terms such as, “sieving medium,” “sieving matrix,” or “separation matrix,” are also used in the art to describe these materials, and are generally considered to be within the scope of “separation media.” Such separation media usually include at least one polymer, and frequently include two or more polymers along with one or more items such as a buffer solution.

Capillary electrophoresis separations are typically more rapid than slab gel separations and the separation media can be replaced after each run if necessary. Capillary electrophoresis can effectively separate up to about 400 bases in less than an hour using current technology. Thus capillary electrophoresis systems offer significant actual and potential advantages in analyzing large numbers of samples. As those familiar with such identification projects as the human genome project are well aware, the sheer numbers of molecules to be identified makes it quite important to automate and speed up as many of the processes as possible.

The theory, background, and practice of capillary electrophoresis are set forth in more detail in the academic literature, and in relevant texts such as Grossman, CAPILLARY ELECTROPHORESIS, THEORY AND PRACTICE, Academic Press (1992); and Weinberger, PRACTICAL CAPILLARY ELECTROPHORESIS, Second Edition, Academic Press (2000). As these and other sources provide an excellent background in the art, the details of capillary electrophoresis will not be discussed in detail herein, other than as helpful or necessary to describe the present invention.

Electrophoresis can be used to separate a DNA sample to identify the sequence of its base pairs. In a typical procedure, a voltage of approximately 10-15 kilovolts(kV) is applied across a capillary filled with a separation polymer and a small sample slug of DNA. This voltage results in a current flow of approximately of five microamps for a capillary of about 50 centimeters length and 50 microns internal diameter. The mobility of the DNA is typically increased by heating the capillary (along with the entrained polymer and sample) to approximately 50° C. DNA fragments are tagged with specific dyes, which fluoresce at known wavelengths when irradiated with the appropriate wavelength of incident light. A typical capillary has an outside diameter of about 300 microns and an inside diameter of about 25-100 microns. The capillaries are often coated with polyimide for added durability and to prevent fluorescence of the entrained sample. A clear aperture is typically located near one end of the capillary. Laser light is focused through this aperture onto the sample. The resulting fluorescence is measured. Some commercial genetic analyzers use four distinct dyes: one for each base type. Each type of dye has a peak fluorescence at a different wavelength in the visible spectrum. A spectrometer is used to discriminate between the various dyes (bases) as they pass along the capillary window.

As noted above, and for a number of reasons, capillary electrophoresis is frequently carried out in fused silica (glass) capillaries of very small diameter. Because capillary electrophoresis, like all forms of electrophoresis, incorporates an electric field to move charged molecules through the separation media, the effects of such field have to be evaluated in a total environment. In particular, the nature of glass is such that a number of negatively charged silicon-oxygen (silanol) groups are present. In the relatively small dimensions of a capillary, these silane groups create an interior circumference of negative charge. This in turn tends to generate a corresponding attraction of positively charged elements in the media toward the circumference of the capillary. This positively charged portion of the medium tends to flow toward the cathode (negatively-charged electrode) in the presence of the electric field that is applied during electrophoresis. Accordingly, it tends to move opposite from the direction of movement of the typically negatively charged molecules being separated that are moving towards the anode (positively-charged electrode). This phenomena is referred to as electroosmotic flow or “EOF,” and acts against the CE separation.

In some cases, electroosmotic flow becomes so severe that the peak width of the CE samples become substantially equivalent to the time period between successive peaks. In other words, the slower fragments begin to spread in a manner that eventually causes the broadened peaks to overlap one another. When the peaks overlap one another, the appropriate separation and discrimination between compounds (e.g. DNA fragments) is lost.

As another factor, the separation media may tend to interact with the samples (or the dyes that typically label the samples) in an undesired manner that is unrelated to CE separation. For example, the type and number of functional groups in the media polymers or in the sample, or in a secondary component such as the dye, can cause an interplay between the sample and the media that undesirably retards the CE process, or prevents or masks the desired separation.

Accordingly, one goal of electrophoresis in most cases is to select a separation media that minimizes the amount of undesired EOF that occurs. Sometimes this is accomplished by selection of the separation media (typically a polymer or a mixture of two or more polymers and a buffer solution), and sometimes it is accomplished by the selection of one or more complimentary or supplemental polymers that are added to the separation media to minimize EOF. In some circumstances the complimentary or supplemental polymer(s) is referred to as a “coating” or “wall-coating” polymer because of the surface-related aspects of EOF and the polymer's function in reducing EOF, even though the polymer does not necessarily literally coat the walls of the capillary. Thus, selecting preferred separation media can be accomplished by maximizing the desired properties of both the primary separation media and the coating polymer.

Additional reasons exist for qualifying, evaluating, and selecting the separation media. Some media may interact undesirably with the type of sample being evaluated, or with the dye or other tag associated with such sample, or both. Some media are too fragile for large-scale operations such as DNA sequencing. Other media are difficult to replace on a desired or needed basis. Yet other media are difficult to prepare and control in a consistent manner.

Accordingly, identifying, testing, and selecting appropriate separation media and appropriate polymers are of significant interest in capillary electrophoresis and in the areas of research that electrophoresis supports.

Commercially available electrophoretic genetic analyzers exist that can simultaneously measure DNA samples across multiple capillaries. These tools, however, use capillaries that are all filled with the same polymer, thereby allowing one to electrophorese a variety of DNA samples using the same separation environment. Nevertheless, no present separation tool is available for efficient screening or evaluation of separation media, and in particular, no instrument is available that is capable of making measurements with multiple capillaries that can be independently filled with distinct separation polymers. In addition, polymer solutions used for capillary gel electrophoresis are very viscous; and no commercially-available instruments permit a variety of viscous solutions to be loaded concurrently.

“Combinatorial chemistry,” is a term used to describe a relatively wide range of experimental activities. Generally these techniques share a common goal of identifying compounds, properties of compounds, methods of making compounds and other related tasks by conducting activities on a larger number of compounds than traditional bench chemistry and doing so in a much more rapid fashion. As such, combinatorial chemistry is synonymous with the term “high-throughput experimentation” (e.g. high-throughput synthesis and screening). In one sense, combinatorial chemistry supplements the traditional bench effort of synthesizing and identifying single (or a very few) compounds and then identifying their properties, by instead screening larger numbers of compounds for certain identified properties. These identified properties may not be—and often are not—the ultimate properties desired from the compound, but instead are properties that identify compounds as being legitimate candidates (or not) for a particular purpose. Groups of materials being screened are typically referred to as “libraries.” The screened compounds may then be tested for the desired ultimate properties, or more frequently are screened in a secondary (or ternary, or further) sense to further qualify the group into a yet smaller number of candidate materials, which are expected to contain the much fewer compounds that have the desired ultimate properties. Combinatorial approaches for polymers, especially nonbiological polymers and other materials are described in U.S. Pat. Nos. 6,294,388 and 6,296,771 for example.

Combinatorial chemistry has become a widely accepted technique (sets of techniques) for identifying many new compounds, particularly pharmaceuticals; e.g., Combinatorial Chemistry, Chemical and Engineering News, Volume 79, No. 35, Aug. 27, 2001 at pp. 49ff.

Therefore, it is an object of the invention to provide methods and apparatus for investigating separation media, preferably as a screening protocol and device in a combinatorial research program.

It is also an object to provide a loading station that is capable of loading a number of viscous polymers into separate capillaries—including loading different polymers into different capillaries—for the purpose of enabling rapid screening of different polymers or different polymer composites based upon a particular set of performance criteria such as separation performance, electroosmotic flow suppression, minimal undesired interaction (e.g. with samples or tags or both), and the like, thereby facilitating the discovery and development of polymers with the desired properties using the combinatorial approach.

Accordingly, it is an object of the present invention in addition to identifying, testing and selecting appropriate CE polymers or polymer compositions, to do so in a rapid and efficient manner and to do so in a manner that incorporates the best and beneficial techniques of combinatorial chemistry.

### SUMMARY OF THE INVENTION

The invention meets these objects with an electrophoretic screening instrument that includes a plurality of capillaries and a loading station at a first end of each capillary for loading the capillary with a flowable separation medium independently from the remainder of said capillaries. The instrument includes a sampling station for adding a charged sample into each capillary, electrodes for applying a potential difference across each capillary to thereby drive the sample through the separation medium, and a detector system for concurrently determining a property of each sample, or a property of a component thereof, in each capillary.

In another aspect, the invention is a loading manifold for capillary electrophoresis and screening. In this aspect the manifold includes a body with a plurality of separate flowpaths in the body for independently loading a plurality of capillaries with a flowable separation media. The flowpaths include a plurality of fluid inlets in the body and a corresponding plurality of fluid outlets in the body, each of which is in fluid communication with a corresponding inlet. The body has a corresponding plurality of reservoirs, each of which is in independent fluid communication with a corresponding flowpath, and an electrode port in communication with the reservoirs.

In a further aspect, the invention is an electrophoretic screening instrument that includes a loading station having four or more independent flowpaths, each of which comprises a fluid inlet and a corresponding fluid outlet, with the inlet being in fluid communication with the outlet to thereby permit fluid flow between the inlet and the corresponding outlet. The loading station has four or more corresponding loading syringes, each of which is in fluid communication with one of the fluid inlets, and four or more corresponding capillaries, each of which has a first end that is in fluid communication with one of the fluid outlets so that the capillaries can be individually loaded with the contents of a syringe through a flowpath of the loading station. The instrument includes a sampling assembly in fluid communication with the opposite end of each capillary for adding a sample to the opposite end of each capillary, circuitry for applying an electric field across each capillary, and a detection system for measuring a property of a sample (or a property of a component of a sample) in each capillary.

In yet another aspect the invention is a method of screening separation media for performance in capillary electrophoresis. The method comprises loading each of a plurality of capillaries from one corresponding end of each with a respective plurality of at least two different separation media and with one media per capillary, introducing a sample into each capillary, advancing the samples through the capillaries under an applied electric field, measuring a property of the samples or components thereof as they advance through the capillaries, using the measured properties to identify one or more preferred sets of separation media, and wherein at least one of the steps of loading or advancing are carried out simultaneously over the plurality of capillaries.

In a further aspect, the invention is a method of screening polymers for electroosmotic flow. The method includes the steps of advancing probe compositions through at least two different electrophoresis capillaries that contain polymer compositions, with the contents of the capillaries differing from one another by the probe composition advanced therethrough or by the polymer composition contained therein or both, measuring the migration time of at least one probe composition in each capillary, loading each capillary with a selected separation polymer and a selected wall-coating polymer, advancing the same probe composition through each respective capillary in the presence of the selected separation polymer and a selected wall-coating polymer, measuring the migration time of each probe composition in the presence of the selected separation polymer and the selected wall-coating polymer, and using the measured migration times to identify one or more preferred members of the group consisting of the probe compositions, the separation polymers, and the wall-coating polymers.

In yet another aspect the invention is a method of screening polymers for electroosmotic flow that includes the steps of concurrently advancing a charged dye compound and a dye-labeled short oligonucleotide through an electrophoresis capillary that is filled with a separation polymer and a first candidate supplemental polymer, measuring the respective migration times for the charged dye compound and the dye-labeled oligonucleotide, repeating the advancing and measuring steps using the same charged dye compound and the same dye-labeled oligonucleotide but with at least a second candidate supplemental polymer, and identifying the first or second candidate supplemental polymer as preferred over the other on the basis of the absolute and comparative migration times of the charged dye compound and the dye-labeled oligonucleotide in each of the advancing and measuring steps.

In a further aspect, the invention is a method of screening polymers for electroosmotic flow that includes the steps of concurrently advancing a charged dye compound and a dye-labeled short oligonucleotide through a plurality of electrophoresis capillaries, each of which is filled with a separation polymer and a supplemental polymer, measuring the respective migration times in each capillary for the dye compound and the dye-labeled oligonucleotide, and identifying preferred members selected from the group consisting of the separation polymers and the supplemental polymers on the basis of the absolute and comparative migration times of the charged dye compounds and the dye-labeled oligonucleotides in each capillary.

The foregoing and other objects and advantages of the invention and the manner in which the same are accomplished will become clearer based on the followed detailed description taken in conjunction with the accompanying drawings in which:

### BRIEF DESCRIPTION OF THE DRAWINGS

FIG. 1 is an environmental perspective view of a capillary electrophoresis system according to the present invention;

FIG. 2 is a perspective view of the syringe pump assembly according to the present invention;

FIG. 3 is a partially exploded perspective view of the valved loading manifold according to the present invention;

FIG. 4 is a cross-sectional view taken along lines 4-4 of FIG. 3;

FIG. 5 is a cross-sectional view taken along lines 5-5 of FIG. 3;

FIG. 6 is another cross-sectional view similar to FIG. 5, but also including the valve stem and the inlet and outlet fittings;

FIGS. 7 and 8 are respective exploded views of the capillary heater according to the present invention;

FIG. 9 is a cross-sectional view taken along lines 9-9 of FIG. 8; and

FIGS. 10-13 are a series of charts illustrating aspects of the conceptual background and resulting advantages of the present invention.

### DETAILED DESCRPTION

The invention is directed to apparatus and methods for effecting efficient evaluation or screening of CE separation media compositions, preferably simultaneous evaluation or screening of separation media compositions that vary with respect to one or more factors affecting capillary electrophoresis analysis of samples such as biological samples or small organic molecules.

The invention provides an integrated relationship among capillaries, sampling structures, loading structures, detectors (including sources for optical detectors) and other elements. It will be understood that such integration can take several forms and is not limited to the embodiment described herein. Such integration can include, but is not limited to, structural integration (e.g. common structural features), functional integration (e.g. common temperature or voltage) or control-based integration (common processors or operating systems).

Stated differently, physically separated structural parts can still form part of an integrated system and the invention herein is not limited to monolithic structures containing the described elements.

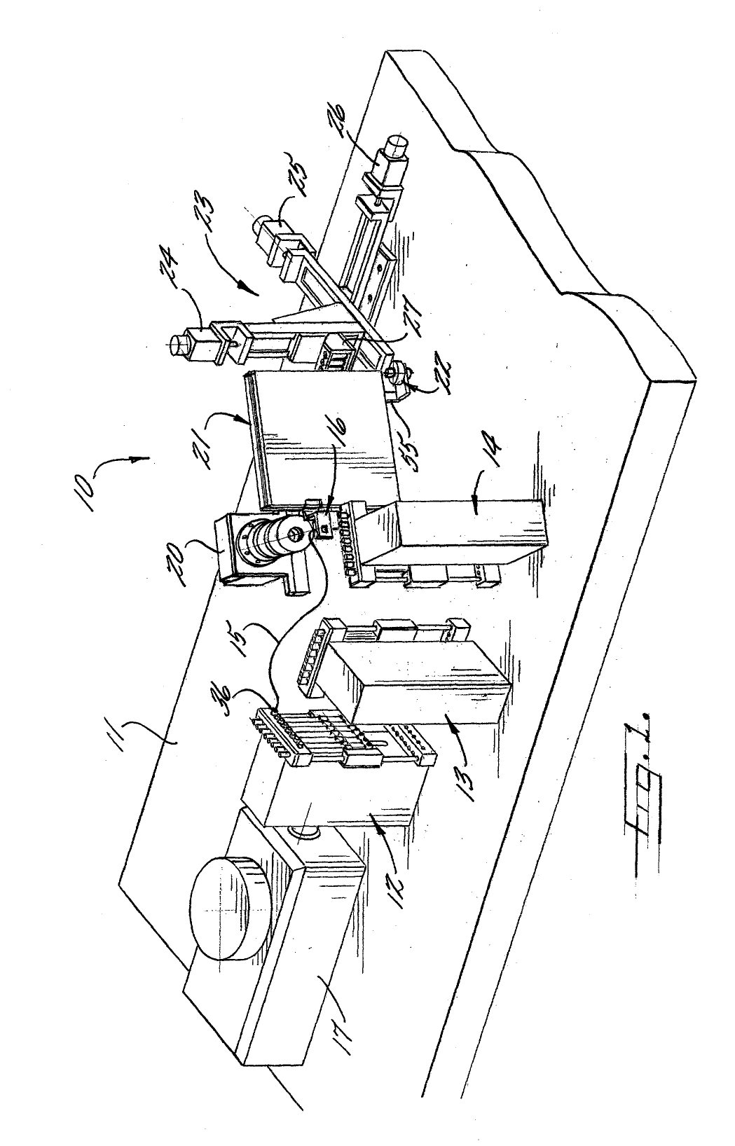

FIG. 1 is an overall perspective view of one embodiment of the instrument according to the claimed invention. The system is broadly designated at 10 and in the presently preferred embodiments is supported by the optical table 11. The broad elements of the system include the capillary loading stations that are respectively broadly designated as 12, 13, and 14. In the illustrated embodiment, each of the loading stations feeds eight capillaries for a total of 24. For the sake of simplicity and clarity with respect to FIG. 1, however, only a single representative capillary 15 is illustrated.

The capillary 15 travels from the loading station to a capillary chuck 16 that holds the capillary in position for detection and that will be discussed in detail with respect to FIG. 8. An argon ion laser 17 is similarly positioned on the optical table 11 and directs laser light at the capillary chuck 16 and the capillary 15. The laser is, of course, selected to produce electromagnetic radiation having a frequency (typically, but not necessarily exclusively, within the visible spectrum) to which the samples are expected to be responsive.

The responsive emission from the sample within the illuminated capillary 15 in the chuck 16 is read by the detector 20 which in preferred embodiments is a thermoelectrically cooled charge coupled device (CCD) camera with an appropriate filter assembly. The general theory and operation of laser sources, and the detection and interpretation of laser-induced fluorescence of the relevant dyes are generally well understood in this art, and the applicable equipment is commercially available. Thus, particular features will not be discussed in detail herein, other than as necessary to explain the invention. Additionally, alternative detection systems can be suitably employed.

As part of a preferred apparatus and method, the system includes heater assembly 21, the structure and operation of which will likewise be discussed in greater detail with respect to FIG. 8. The heater is adjacent the high voltage electrode and capillary terminal 22. The terminal 22 is in turn adjacent a sampling station broadly designated at 23. The sampling station 23 typically includes one or more stages depending upon the degrees of movement desired. FIG. 1 illustrates three stages respectively indicated at 24, 25 and 26 which provide for movement in three dimensions (e.g. x-y-z). In particular, the stages of the sampling station are used to carry a plurality of vials (which in the scale of FIG. 1 are too small to be usefully numbered) in a rack 27 for the purpose of loading samples into the capillaries in a manner described elsewhere herein in more detail. In preferred embodiments the stages 24-26 are ball screw stages that are otherwise conventional in the art and commercially available. Alternative translation instruments or robotics could likewise be employed.

Accordingly, in a first embodiment, the invention comprises an electrophoretic screening instrument 10 which includes a plurality of the capillaries 15 and means shown as the respective loading stations 12, 13 and 14 for loading each capillary 15 with a flowable separation medium independently from the remainder of the capillaries. The instrument includes means shown as the staging assembly 23 and the electrode and capillary terminal 22 for adding a charged sample into the opposite end of each capillary 15. The electrode 22 (in accordance with a complimentary oppositely charged electrode that is not shown in FIG. 1) applies a potential difference (electric field) across each capillary 15 to thereby drive the sample through the separation medium. Finally, in this aspect, the invention includes a detector system, illustrated as the laser source 17 and CCD camera 20 for concurrently measuring a property of each sample (or a component of each sample) in each capillary 15.

In particular, the detector system includes a source shown as the laser 17 for directing electromagnetic radiation onto the capillaries 15 and their contents (e.g. samples or sample components), with the detector 20 measuring the effect of the electromagnetic radiation on the samples in the capillaries 15. In presently preferred embodiments, the CCD camera 20 measures the fluorescence generated by the samples in the capillaries 15 when they are illuminated by the laser 17.

Fluorescence is a preferred technique because of its sensitivity and compatibility with small sample sizes. It will be understood, however, that other detection techniques can be incorporated as desired or as necessary. Among optical detection techniques, transmittance, absorbance, phosphorescence, or scattering methods can be used to identify and characterize samples. Such techniques are well understood in this art and can be incorporated as needed or desired without undue experimentation.

In a broader sense, the detector can comprise either a parallel (e.g. staring) detector or a scanning detector with a staring detector embodied by the CCD camera 20 being illustrated in FIG. 1. A parallel detection is a detector adopted and arranged for simultaneous detection of a sample or component thereof in each of two or more capillaries. The term, “staring detector” is used herein to describe a stationary detector that maintains a constant (temporally and spatially) vigil over the area in which it is pointed, and can be or include a focal plane array. A staring detector brings the advantage of few, if any, moving parts and continuous coverage of the field of view. It depends upon a mosaic of detector elements placed at the focal plane of the optical system and “sees” the complete scene (or some desired subset of the scene) in a single view. This arrangement produces a spatial as well as temporal differentiation of the target and thus produces more data for possible target identification and clutter rejection.

Such staring systems continuously measure the fluorescence emanating from each capillary 15. The detector can be a CCD (the preferred embodiment), multiple photodiodes, or a multiple photo-multiplier tubes. A single laser can be used to illuminate all channels. The system can utilize capillaries configured in a planar orientation (the preferred embodiment), or an axis-symmetric configuration. The latter configuration enables a more compact grouping of the capillaries, which maybe advantageous in some instances. The optical system, however, is generally more complex.

A scanning detection system can also be used. A scanning detector observes successive portions of its field of view in accordance with a sequential system of scan. In this type of system, a measurement is made by rastering the optical element relative to the fixed capillaries (or vice versa). Each capillary (or subgroup of capillaries) is thereby illuminated sequentially. This type of system enables the use of a single optical path, thereby reducing equipment costs, and facilitating packaging. The primary design constraint for this type of system is the scanner. The objective (and steering optics) is preferably scanned over a distance of approximately 5 mm at a frequency of at least 5 hertz. The path of the objective is preferably flat relative to the fixed capillary bed, and a quality stage is thus required. Data collection for this type of system can be effected, for example, with at least 10 data points acquired from each capillary as the objective scans across. This translates to a detector measurement bandwidth requirement of about up to 15 kilohertz, which can increase the noise inherent in a measurement.

With respect to the optical detection systems, the function of illuminating the sample can be (and typically is) decoupled from the function of observing or measuring the output from the sample generated by the illumination. In turn, both illumination and detection can be independently carried out in one of four possible schemes: parallel for all capillaries; parallel for a subset of capillaries; sequentially for all capillaries; or sequentially for a subset of capillaries. Such combinations can include a plurality of lasers, or a plurality of detectors, or both. Indeed, the rapid growth in availability of solid-state sources (e.g. light emitting diodes) and detectors (e.g. photodiodes) for an increasing range of visible, IR, microwave and UV frequencies provides the possibility of individual sources and detectors for individual capillaries.

As illustrated in FIG. 1, in preferred embodiments the invention includes three of the loading stations 12, 13 and 14, and comprises a plurality of syringes 30, with each of the syringes 30 corresponding to one of the capillaries 15. In preferred embodiments, the staging assembly 23 adds a sample into each capillary 15 and thereafter positions the opposite end of each capillary in a buffer solution for the capillary electrophoresis operation.

In preferred embodiments, each of the capillaries 15 can be loaded with a different separation medium. Given this degree of flexibility, other permutations can be carried out even more easily. Thus, some of the capillaries can be loaded with the same separation medium while others are loaded with a second (or second and third, etc.) separation medium. The design of the instrument allows a high degree of flexibility in loading different separation medium and thus in carrying out combinatorial techniques using the instrument. The instrument includes a plurality of capillaries; generally at least four capillaries, more preferably at least eight capillaries, and in presently preferred embodiments at least twenty-four capillaries.

As used herein, the term “different” includes its accepted definition (e.g. “partly or totally unlike in nature, form or quality,” MERRIAM-WEBSTER ONLINE DICTIONARY, 2001) and in most cases refers to a compositional difference in the separation media. Differences in separation media can additionally (or alternatively) also include differences in physical properties due to factors other than composition, such as differences due to environmental conditions (e.g. temperature). With respect to separation media, such differences can include (but are not limited to) one or more of: different polymers (i.e. different composition, different repeat units, different ratios of repeat units, different ordering or arrangement of repeat units or different chain architectures), different molecular weights, different buffers, different combinations of two or more polymers, different concentrations of polymer solutions, and different physical properties (e.g. viscosity, conductivity, refractive index, etc.), and combinations of these factors.

Stated in the negative, “different” as used herein generally means a difference other than spatial positioning (e.g. merely being located in separate capillaries).

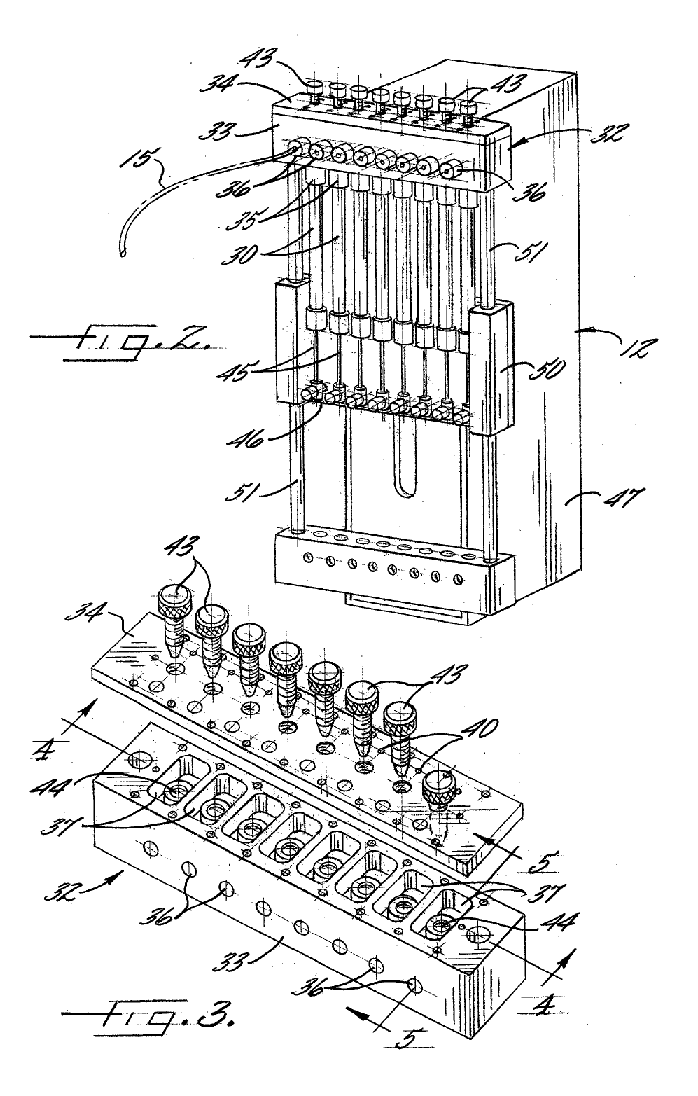

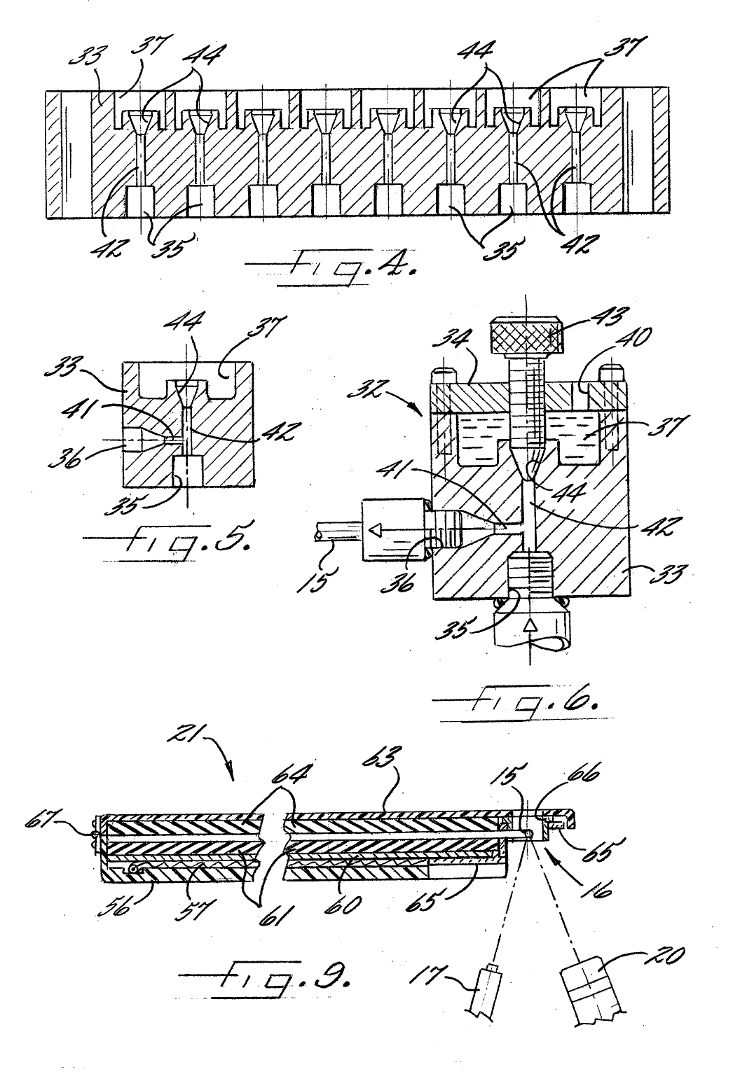

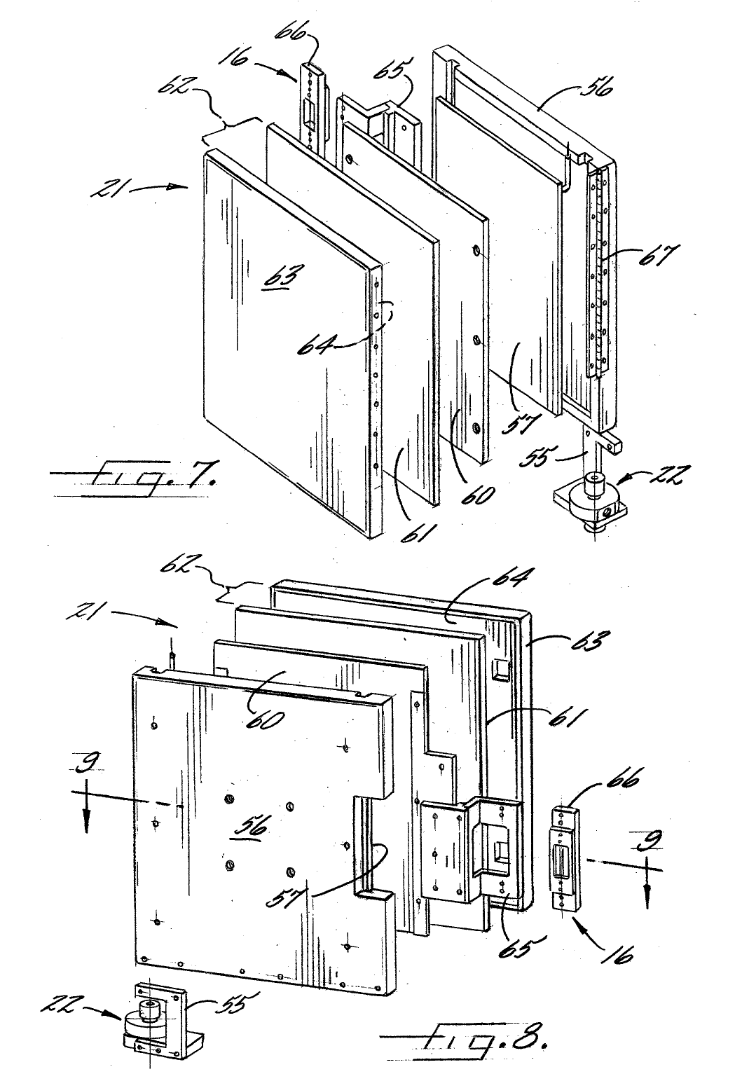

FIG. 2 is an enlarged perspective view of one of the loading stations 12 previously illustrated in FIG. 1. The loading station 12 includes a loading manifold broadly designated at 32. The details of the loading manifold 32 are further illustrated in FIGS. 3 through 6. Accordingly, FIG. 3 illustrates that the loading manifold 32 includes a body, which in the preferred embodiment is a multipiece body, preferably comprising a plurality of laminae having integral structural features, and as illustrated, is formed of the lower body portion 33 and a cover portion 34. The manifold body includes at least one, and preferably a plurality of separate flowpaths for independently loading a plurality of capillaries with a flowable separation media. The flowpaths include a plurality of fluid inlets 35 which are best illustrated in FIGS. 4-6. The body 33 has at least one, and preferably a plurality, of corresponding outlets 36 each of which is in fluid communication with one of the corresponding inlets 35 through the respective flowpaths defined by a first passageway 41. The body 33 includes at least one, and preferably a corresponding plurality, of reservoirs 37 each of which is in independent fluid communication with the flowpath (e.g. passageway 41) between the corresponding inlet 35 and outlet 36, and hence is in independent fluid communication with one corresponding inlet 35 and one corresponding outlet 36 in a manner best illustrated in FIG. 5. Because one advantage of the invention and method is the ability to segregate the contents of the capillaries from one another (i.e., to use different media in different capillaries), the reservoirs 37 are preferably similarly segregated from one another and do not communicate with one another. Stated differently, each reservoir's fluid communication is dedicated to (i.e. preferably limited to) one inlet, one outlet, and one capillary. The body 33 also includes a plurality of electrode ports 40 (FIG. 6) each of which is in communication with one of the reservoirs 37. As perhaps best illustrated by taking FIGS. 3 and 6 in combination, in the preferred embodiment the electrode port 40 is cut through the cover portion 34 to give access to the reservoir 37.

FIGS. 5 and 6 also illustrate that each loading station includes a first fluid passageway 41 that connects each inlet with its respective outlet 36, a second fluid passageway 42 that connects the reservoir 37 to at least one of the inlet 35 and the outlet 36, and a valve shown as the combination of the value screws 43 and their seats 44 for closing the second fluid passageway 42 to thereby limit (i.e. isolate) fluid flow to the first passageway between the inlet 35 and the outlet 36 while isolating the reservoir 37 from the fluid flow.

It has been particularly discovered with respect to the present invention that in the absence of the reservoirs 37, the charge carrier concentration becomes depleted. This in turns lowers the current to an undesired or unworkable level.

In particular, the valves formed by the screws 43 and the seats 44 facilitate both the loading and separation capabilities of the instrument 10. When loading the capillaries 15 with the separation media, the valve screws 43 are fully engaged in the seats 44. This orientation (illustrated in FIG. 6) limits fluid flow to a path between the inlets 35 and the outlets 36, while segregating the reservoirs 37. Thus, fluid-separation media-injected from fluid sources illustrated as the syringes 30 moves directly to the capillaries 15 and avoids the reservoirs 37. Once the capillaries are loaded with separation media, the valve screws 43 are backed out to permit fluid communication between the reservoirs 37 and the capillaries 15. In turn, the desired buffer is added (either before or after opening the valves) to the reservoirs 37 to facilitate the electrophoresis process.

In a preferred embodiment, the loading station has four or more of the independent flowpaths, four or more corresponding syringes, four or more corresponding reservoirs and four or more corresponding electrode parts.

In this manner each reservoir and capillary can have an independent electrode, and if desired, an independently controlled electric field can be applied to each capillary using appropriate circuitry.

Accordingly, the general operation of the loading manifold is as follows: The capillary 15 is first filled with the separation polymer. One end of the capillary 15 and the cathode electrode (not shown) are inserted into a vial containing a running buffer solution and the current is applied to equilibrate the system. Thereafter, the sample end of the capillary is inserted into a vial containing the DNA sample. The other end of the capillary 15, and the anode electrode (not shown) are immersed in a buffer solution, including the buffer in the reservoir 37 as just described. A portion of the DNA sample is injected into the capillary 15 under the action of an applied voltage. The potential difference is removed. The end of the capillary 15 is then removed from the DNA sample and immersed in a buffer solution. Voltage is applied again to continue electrophoresis.

FIG. 2 further illustrates that the loading station 12 also includes a plurality of the syringes 30, each of which is in fluid communication with one of the inlets 35 for loading capillaries that are in communication with the outlets 36 with the contents of the respective syringes 30. The term “syringe” is used herein in its normal sense to include a shaft (tube) and plunger for loading a liquid into a smaller diameter tube, in this case, the inlets 35 and thereafter, the capillaries 15. In preferred embodiments, the loading station and manifold further comprise means for concurrently delivering the contents of the syringes 30 into the inlets 35 and thus into the capillaries 15. In particular, FIG. 2 illustrates that the inlets 35 are arranged in a single row, and the syringes 30 engage the manifold body 33 in a corresponding single row. The concurrent delivery means comprises a stepper motor (not illustrated) operatively connected to the plungers of the syringes for driving the plungers to deliver a fluid to the inlets. In the most preferred embodiment, the plungers are fixed to a plate 46 and the motor drives the plate 46 and thus the plungers of the syringes 30. In the preferred embodiment, the stepper motor is contained within the housing 47 and the plate 46 is part of a linear bearing 50 that rides along appropriate shafts 51, that are typically and preferably formed of metal. The nature and operation of linear bearings are generally well understood and will not be discussed in further detail herein.

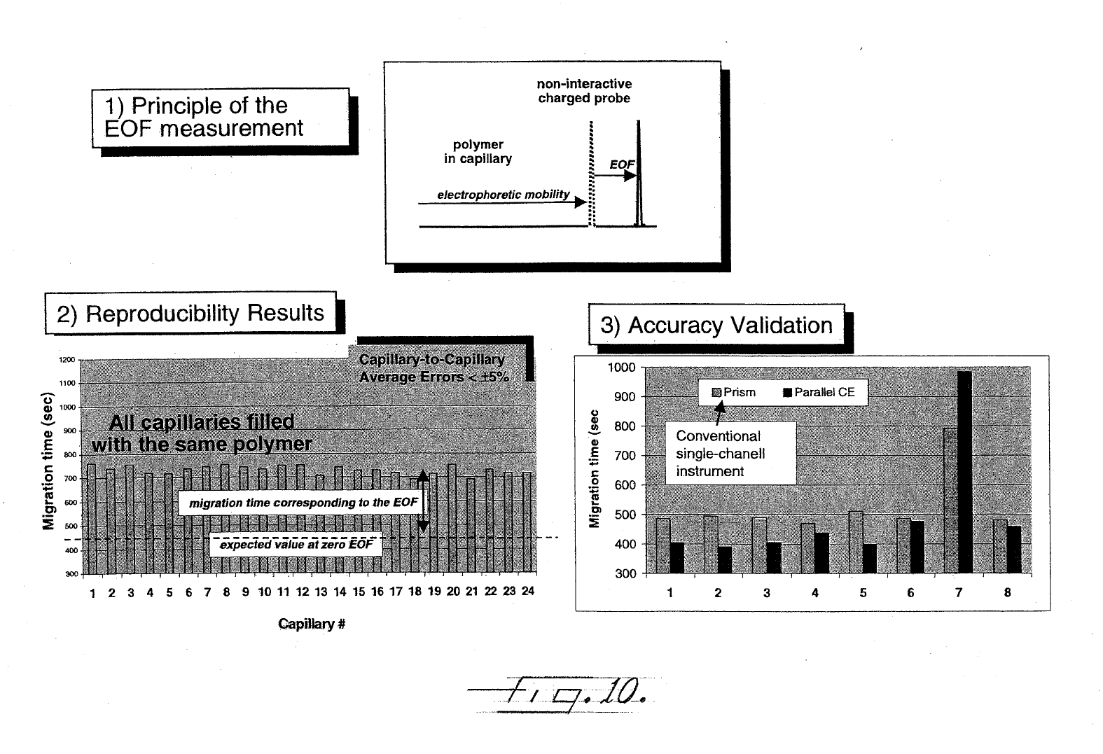

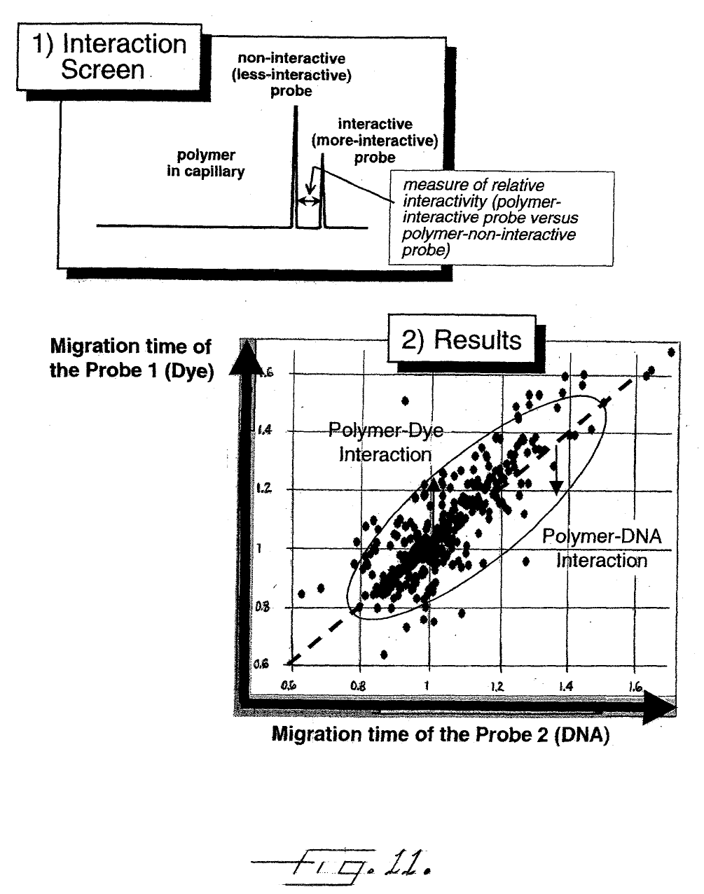

FIGS. 7, 8 and 9 illustrate the heater assembly 21 in greater detail. Heating capillaries (and in a related manner, keeping capillaries at a desired temperature) is a technique generally well understood in capillary electrophoresis. It offers several advantages such as increasing the mobility of the samples, improving the reproducibility of the results, and minimizing or eliminating current fluctuations. The heater assembly 21 is fixed to the optical table 11 by a bracket 55 that also commonly supports the electrode and capillary terminal 22. A back plate 56 which is preferably formed of an engineering plastic as such Torlon™ (polyamide-imide, and preferably glass-reinforced) carries a resistance heater plate 57. The resistance heater plate 57 is immediately adjacent (for heat transfer purposes) the aluminum heater plate 60 which serves as the main heat transfer mechanism to the capillaries 15 (not shown in FIGS. 7 and 8). For proper electrical protection, the charged capillaries should avoid contacting the metal portions such as the heater plate 60. Similarly, because direct contact with the heater plate 60 or the heater 57 would cause a short circuit and likely damage the capillaries, a layer of silicone rubber 61 is interposed between the aluminum heater plate 60 and the capillaries. When the heater assembly 21 is in operation, the capillaries 15 occupy the space indicated by the bracket 62 in FIG. 7. The heater assembly 21 is completed with a front door 63 typically formed of a polymer resin such as Delrin™ (an acetal (polyoxymethylene) resin) which also carries another layer (64 in FIGS. 8 and 9) and that is hinged to the back plate 56. FIGS. 7 and 8 also illustrate that the capillary chuck assembly 16 is preferably formed of two portions including a bracket 65 that is fixed to the heater assembly 21 and a chuck 66 that fits into the bracket 65.

The chuck assembly 16 holds the capillaries in the desired position for both illumination and emission (detection) (FIG. 9). Additionally, the chuck assembly 16 should preferably maintain the capillaries in thermal contact with the heater assembly 21 (to maintain a desired above-ambient temperature), but not in electrical contact with it (to avoid short circuit problems). Accordingly, the bracket 65 is preferably formed of a heat conductive, but electrically insulating material. In preferred embodiments, the bracket 65 is formed of a boron nitride ceramic.

Because the bracket 65 is electrically insulating, the chuck 66 can be formed of metal (preferably aluminum) without risk of short circuits. Metal is preferred for the chuck 66 because the chuck's relatively detailed design features are most easily and accurately formed in metals.

When assembled, the silicon rubber layer 61, the aluminum heater plate 60, the heater 57, and the back plate 56 are all attached to one another (i.e. fixed) while the front door 63 and the silicone rubber layer 64 on its opposite side can pivot on the hinge 67 so that the entire heater assembly can be opened and closed as necessary to place or position the capillaries 15.

The invention also has a number of method aspects.

In one method aspect, the invention is a method of screening separation media for performance in capillary electrophoresis. In this aspect, the method comprises concurrently loading a plurality of capillaries from one corresponding end of each with a respective plurality of at least two different separation media, and with one media per capillary. As used herein, the term media includes, but is not limited to, separation media. Such media can include, but is not limited to, separation polymers, wall-coating polymers and buffer solutions, potentially along with other compounds or compositions. For example, the separation media can be a compound or composition effective for separating biological polymers (e.g. natural or synthetic proteins or polynucleotides), nonbiological polymers, and small organic molecules (e.g. chiral molecules).

In the next step, the method comprises introducing a sample (e.g. a standard mixture of oligonucleotides) to (typically) the opposite end of each capillary; i.e. corresponding ends of each capillary are loaded with the separation media, and corresponding opposite ends of each capillary are loaded with the sample.

The next step comprises advancing the samples through the capillaries under an applied electric field; i.e. capillary electrophoresis. Thereafter a property of the samples (or of components of the samples) is measured as the samples advance through the capillaries and the measured properties are used to identify one or more preferred sets of separation media. In preferred embodiments, at least one of the steps of loading or advancing are carried out simultaneously over the plurality of capillaries.

In preferred embodiments, the step of loading the capillaries comprises loading the capillaries with compositions selected from the group consisting of separation polymers, wall-coating polymers, buffer solutions, potentially along with other compounds or compositions. For example, the separation media can be a compound or composition effective for separating biological polymers (e.g. natural or synthetic proteins or polynucleotides), nonbiological polymers, and small organic molecules (e.g. chiral molecules) and combinations thereof.

In a more preferred embodiment, the screening method comprises loading the capillaries from a library of candidate separation media, including, but not limited to libraries of separation polymers, wall-coating polymers, buffer solutions, potentially along with other compounds or compositions. For example, the separation media can be a compound or composition effective for separating biological polymers (e.g. natural or synthetic proteins or polynucleotides), nonbiological polymers, and small organic molecules (e.g. chiral molecules) and combinations thereof.

The nature of the method provides a great deal of flexibility. Thus, the method can comprise loading each capillary with the same separation polymer, but with a different wall-coating polymer. Alternatively, the method can comprise loading each capillary with the same wall-coating polymer and with a different separation polymer.

It will be understood that the wall-coating and separation polymers can be loaded together and that they are expressed herein as separate loading steps simply for the purpose of clarity and not as a limitation on the particular technique.

In another alternative variation, the method can comprise loading some but not all of the capillaries with the same separation polymer or loading some but not all of the capillaries with the same wall-coating polymer. It will be understood that these techniques provide for a wide variety or large number of permutations of loading schemes that takes advantage of the method for the purpose of quickly identifying favorable properties of a relatively large number of candidate materials (or alternatively eliminating them as candidate materials based on their lack of desired characteristics). As noted above with respect to combinatorial chemistry, the identified properties may be either the ultimate desired properties of the separation media or may be properties that are observed simply for the purpose of screening the media—or individual elements of the media—for follow up screening or analysis.

In preferred embodiments, the step of adding the sample to the opposite end of each capillary comprises adding a sample selected from the group consisting of DNA, DNA fragments, other nucleotides or oligonucleotides, polysaccharides, polyelectrolytes, proteins, small organic molecules, non-biological polyelectrolytes, and combinations thereof.

Additionally, as set forth with respect to the device aspects of the application, the step of measuring a property of the samples following separation of the capillaries typically comprises an optical (spectroscopic) measurement. In the most preferred embodiment, the capillaries are illuminated by a laser, and the resulting fluorescent emission is detected and quantified.

In turn, by identifying preferred CE separation media, the screening method provides for an improved capillary electrophoresis method. In this aspect, the invention comprises identifying a preferred set of separation media using the method just described, and thereafter conducting capillary electrophoretic separation of desired samples using the identified preferred set of separation media. In this aspect, the invention can further comprise separating one or more members of the group consisting of DNA, DNA fragments, other nucleotides or oligonucleotides, polysaccharides, polyelectrolytes, proteins, small organic molecules, nonbiological polyelectrolytes, and combinations thereof.

In another aspect, the invention comprises a method of screening polymers for suitability for capillary electrophoresis, including the effects of electroosmotic flow (EOF). In this aspect, the invention comprises advancing probe compositions (e.g. a dye) through a plurality of electrophoresis capillaries that are filled with a selected separation polymer and in the absence of a wall-coating polymer. The method then comprises the step of measuring the migration time of at least one probe composition (dye) in each capillary. Thereafter the method comprises filling each capillary with a selected separation polymer and a selected wall-coating polymer, and then running the dye through the respective capillaries in the presence of a selected separation polymer and a selected wall-coating polymer. The migration times of each of the dyes in the presence of the selected separation polymer and selected wall-coating polymer are then measured, and the measured migration times are used to identify one or more preferred members of the group consisting of the dyes, the separation polymers, and the wall-coating polymers. Generally, the dyes are standardized and well-understood and thus the identification is most commonly more valuable for either the separation polymer or the wall-coating polymer or both.

In more detail, the measured migration time of the dye through the buffer in the capillary can be thought of as the migration time of the dye in the buffer in the absence of EOF plus the additional migration time caused by the EOF acting against the migration. Thus, when the dye is re-run in the presence of a selected polymer, particularly a candidate wall-coating polymer, the migration time again represents the electrophoresis time in the presence of EOF. Thus, polymers that reduce EOF can be identified, at least broadly and potentially in detail, by this aspect of the method.

In preferred permutations and combinations of the method, the running steps can comprise using the same separation polymer in each capillary or using a different separation polymer in each capillary. Similarly, the running steps can comprise using the same dye in each capillary or using a different dye in each capillary. Again, in the same manner, the method can comprise using the same wall-coating polymer in each capillary or using a different wall coating polymer in each capillary. It will thus be understood that the method provides for a wide variety of permutations and combinations of the use and evaluation of separation polymers and wall-coating polymers. Stated more broadly, the running steps can comprise keeping one member of the group consisting of dyes, the separate polymers, and the wall coating polymers the same in each capillary while varying the other two members of the group among the capillaries. Similarly, but alternatively, the running steps can comprise keeping two members of the group consisting of the dyes, the separation polymers and the wall-coating polymers the same in each capillary while varying the third member of the group among the capillaries.

In a manner similar to the other embodiments the step of measuring the migration time of the dyes in each of the measuring steps preferably comprises optical detection following appropriate separation, with the preferred method being measuring the fluorescence emitted from each capillary following stimulation with laser light.

In a preferred embodiment of this aspect of the invention, the step of filling each capillary with a selected separation polymer and a selected wall-coating polymer comprises concurrently filling the plurality of capillaries with these polymers.

In yet another aspect, the invention is an additional method of screening polymers for capillary electrophoresis. In this aspect, the method comprises concurrently running a charged (i.e., to move under the influence of the applied electric field) dye compound and a dye-labeled short oligonucleotide through an electrophoresis capillary that is filled with a separation polymer and a first candidate supplemental polymer. Thereafter, the method comprises measuring the respective migration times for the charged dye compound and the dye-labeled oligonucleotide; followed by repeating the running and measuring steps (in parallel or serial fashion) for at least a second candidate supplemental polymer; and thereafter, identifying the first or second candidate supplemental polymer as preferred over the other on the basis of the absolute and comparative migration times of the charged dye compound and the dye-labeled oligonucleotide.

This aspect of the invention adds another (favorable) layer of discrimination between polymers to the method. When the dye and the dye-labeled nucleotide (i.e., short oligonucleotide) are run together, a large separation between them (the dye typically migrates faster) tends to indicate that the particular polymer being characterized exerts too much EOF. Alternatively, if both migration times (dye and nucleotide) are too slow, the polymer is generally characterized as being generally unsuitable for CE purposes.

The overall result is an excellent primary screen for polymers that can improve upon current commercially available separation and wall-coating polymers.

As noted above, the method permits the running and measuring steps to be repeated in either serial or parallel fashion as may be desired, thus taking advantage of combinatorial techniques.

The screening method in turn provides for an advantageous capillary electrophoresis technique, which comprises identifying the preferred wall-coating polymer in accordance with the method just set forth, and thereafter, adding the preferred candidate wall-coating polymer to another electrophoresis capillary and carrying out an electrophoretic separation of a nucleotide-containing composition in the presence of the identified, preferred wall-coating polymer.

In preferred embodiments, the capillary electrophoresis method comprises separating one or more members of the group consisting of DNA, DNA fragments, other nucleotides or oligonucleotides, polysaccharides, polyelectrolytes, proteins, small organic molecules, nonbiological polyelectrolytes, and combinations thereof.

As in the other embodiments of the invention, the step of measuring the CE migration time is preferably an optical measurement and is most preferably a measuring of the fluorescence generated from the respective capillaries when they are excited with laser light.

In another aspect, the method of the invention comprises concurrently running a (charged) dye compound and a dye-labeled short oligonucleotide through a plurality of electrophoresis capillaries, each of which is filled with a separation polymer and a supplemental (e.g. wall-coating) polymer. Thereafter, the method comprises measuring the respective migration times in each capillary for the dye compound and the dye-labeled oligonucleotide, and then identifying preferred members selected from the group consisting of the separation polymers and the wall coating polymers on the basis of the absolute and comparative migration times of the charged dye compounds and the dye-labeled oligonucleotides in the each capillary.

The use of a plurality of capillaries provides for preferred alternative steps of filling each capillary with the same separation polymer or filling each capillary with a different separation polymer. Similarly, the method can comprise filling some but not all of the capillaries with the same separation polymer.

Alternatively, the method can comprise filling each capillary with the same wall coating polymer, filling each capillary with a different wall coating polymer, or filling some but not all of the capillaries with the same wall coating polymer.

More preferably, the screening method comprises running a library of separation polymers or wall coating polymers (or both) against a standard set of selected oligonucleotides with one member of the library in each one respective capillary.

Additionally, and perhaps most preferably, the screening method comprises running a library of selected combinations of separation polymers, or of wall-coating polymers, or of desired combinations of separation polymers and wall-coating polymers.

As in the other embodiments, the step of measuring the respective migration times preferably comprises an optical detection method and most preferably comprises measuring the fluorescence from each capillary following its excitation with a laser source.

The method likewise provides for an improved capillary electrophoresis technique which comprises identifying a preferred member of the group consisting of separation polymers, wall-coating polymers and combinations thereof according to the method just described and thereafter adding the preferred member (or combination) to another electrophoresis capillary and carrying out an electrophoretic separation of one or more oligonucleotide containing compositions in the presence of the identified preferred member.

### EXAMPLES

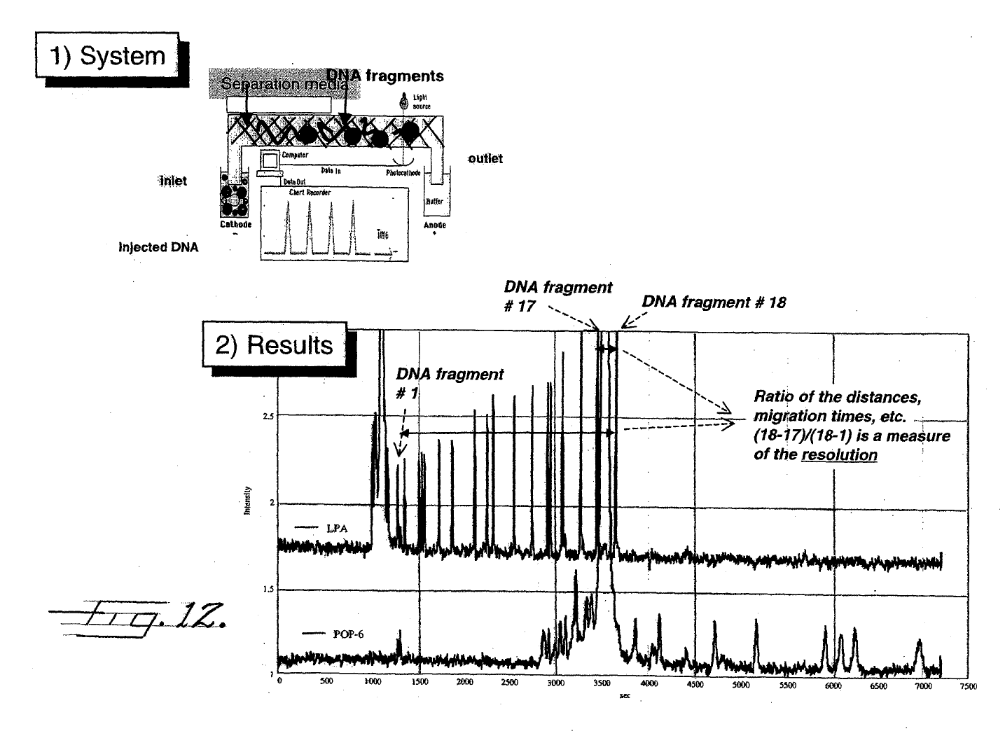

FIGS. 10-13 illustrate exemplary results using the method and instrument of the prsent invention.

FIG. 10 illustrates the nature of the electroosmotic flow screen, which measures the effect of a medium (typically a polymer solution) in a capillary on the electroosmotic flow (EOF). FIG. 10(i) illustrates the effect of EOF and shows that the migration time (abscissa) of a non-interactive charged probe will be extended by an amount of time that corresponds to the EOF effect.

FIG. 10 (ii) is a bar chart illustrating the reproducibility results when all of the capillaries are filled with the same polymer. The dotted line corresponds to the expected value if there were no EOF, while the portions of the bars above the line illustrate the increased migration time that results from the EOF. As illustrated in FIG. 10 (ii), the average difference between capillaries was less than 5%.

FIG. 10 (iii) shows the validation of the accuracy of the method by comparing the results in a conventional single-channel Prism instrument with the parallel capillary electrophoresis instrument of the present invention.

For the FIG. 10 samples, the EOF buffer was prepared from an ABI commercial buffer (3700 running buffer, 1 molar, TAPS at a pH of 8 with ten millimolar EDTA) diluted 20× with deionized water, with urea added to a concentration of 3.5 molar.

The polymer solution was a control polymer of PDMA from ABI in a 0.1 weight percent solution in the EOF buffer solution. The dye labeled DNA/primer solution and dye solutions were made up in an appropriate concentration for detector response in volumes of 200 microlitres. 250 microlitre syringes were washed in preparation and a set of 24 capillaries (50 μm internal diameter) were arranged each having a total length of 72 centimeters with a 36 centimeter length from the detection window to the injection end of the capillary.

The system was brought to equilibrium by flushing the capillaries slowly with 10 microlitres of polymer solution and then equilibrating for 30 minutes at 15 kilovolts at 50 degrees centigrade.

In the injection step, the capillaries were flushed with 5 microlitres of polymer solution before every injection. The injection conditions for either the dye or the labeled DNA primers were a voltage of 10 kilovolts, for 60 seconds, and 3 seconds of ramp time. Four injections of two probes were made for each polymer solution at a voltage of 15 kilovolts and a temperature of 50° C.

In preferred embodiments the detection was carried out using fluorescence detection with data acquisition and processing performed using appropriate software and algorithms. The average of the migration times was calculated excluding the first runs and a typical run time for the dye and the DNA was about 15-20 minutes depending upon the polymer.

In order to test and validate parallel CE against commercial single-capillary instrumentation (FIG. 10 (iii)), the sample and buffer preparation and equilibrium steps were carried out in the same manner. In the single channel evaluation, the capillaries (50 μm I.D.) had a total length of 47 cm with 36 cm of length between the detection window and the injection end. Table 1 shows the injection and running conditions and the manner in which they were different and could be compared as follows:

TABLE 1

| | Injection | Injection | Run | Run |
|---|---|---|---|---|
| System | Time (sec) | Voltage | Voltage | Temperature (° C.) |
| Prism 310 | 3 | 1.5 | 9.4 | 50 |
| (ABI) | | | | |
| Parallel CE | 60 | 10 | 15 | 50 |

FIG. 11 illustrates the interactivity screen according to the present invention. The interactivity screen measures the relative interactivity of polymers with charged solutes (typically a dye and DNA).

The samples illustrated in FIG. 11 were prepared in the same manner as those illustrated in FIG. 10.

FIG. 1(i) shows the interaction screen for two different probes placed in the same capillary. The first is a non-interactive or less interactive probe and the second is an interactive or more-interactive probe. The difference in migration time (abscissa) as between the two probes is a measure of relative interactivity of the two probes. FIG. 11 (ii) shows the results with the migration time of the less interactive probe (typically the dye) plotted on the ordinate as against the migration time of the DNA probe plotted on the abscissa. As a result, samples that show an undesirably large amount of polymer-dye interaction fall above and to the left of the mid-line of the diagram, while those showing an undesirably large interaction between the polymer and the DNA fall below and to the right of the mid-line of the diagram.

The illustrated test is a molecular interaction screen based on a difference in migration of two charged probes using capillaries filled with polymer solutions. Typically, a fluorescein dye and a fluorescein-labeled oligo-DNA are used as the probes of different interactivity. As indicated by FIG. 11 (ii), the deviation in their migration time can be used as a measure of the polymer-dye and/or the polymer-DNA interactivity.

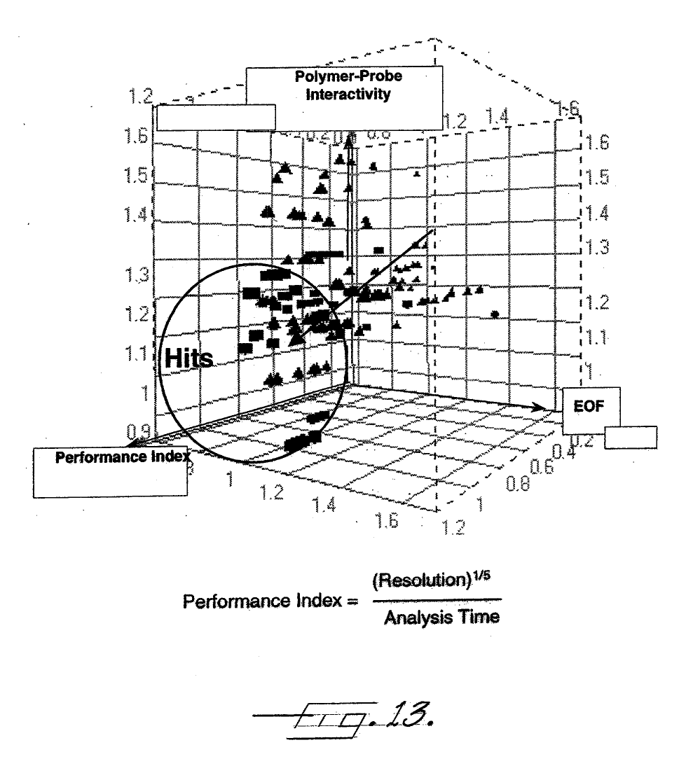

FIG. 12 illustrates the results of a separation resolution screen. This screen measures the effect of polymers on the selectivity of controlled interactivity with charged solutes. The goal is to develop a primary screen enabling the parallel electrophoretic separation of the DNA fragments contained in the PE standard solution through multiple capillaries. In turn, the primary screen enables the rapid screening of polymers based on their separating efficiency. The PE standard solution is a mixture of DNA fragments of known lengths. The solution contains 18 different fragment lengths, which vary from between 75 bases to 700 bases.

The results are evaluated in conjunction with a figure of merit (“FoM”) which is computed (when using an 18-base standard solution) according to the formula FoM=(t₁₈−t₁₇)/(t₁₈−t₁), where t is the elapsed time when the respective fragment traverses the detection window. A candidate (i.e., favorable) separation polymer will have a relatively high figure of merit based on this formula.

Accordingly, FIG. 12(i) is a schematic diagram of the system and FIG. 12 (ii) shows the results. As shown in FIG. 12 (ii), the difference in migration time between the 17^{th} and 18^{th} fragments is divided by the difference in migration time between the 1^{st} and 18^{th} fragments and gives a measure of the resolution.

The preparation steps were generally similar to those of the samples used in the tests illustrated in FIGS. 10 and 11. The EOF buffer was an ABI commercial buffer (3700 running buffer 1 M TAPS at a pH of 8, and 10 mM of EDTA) diluted ten times with deionized water with urea added to a concentration of 7 molar.

The polymer solution was a 2 percent by weight polyacrylamide and a 0.2 percent by weight polydimethylacrylamide (both from ABI) in the EOF buffer.

Respective 200-microliter solutions of a mixture of 18 DNA segments labeled with a dye (ABI) were used at a 1:5 dilution with a denaturing buffer. Twenty-four capillaries (50 μm I.D.) were used with a total length of 72 centimeters with 36 centimeters of the length being between the detection window and the injection end.

The equilibrium step was carried out by flushing the capillaries slowly with ten microliters of the polymer solution and then equilibrating for 30 minutes at 15 kilovolts at 50° C.

The injection step was carried out by flushing the capillaries with 5 microliters of the polymer solution before every injection. The injection conditions for the labeled DNA were a voltage of 4 kilovolts, a time of 30 seconds, and a 3 second ramp time. Four injections of DNA were made for each polymer solution at a running voltage of 15 kilovolts and a temperature of 50° C.

Fluorescence detection was used with data acquisition and processing performed using Symyx proprietary software in which an average of migration times were calculated excluding the first runs.

FIG. 13 plots the results of the probe-probe interactivity with the results of the EOF measurement, and then on a third axis against a performance index, which is calculated as the fifth root of the resolution divided by the analysis time. In this manner, polymers that give the highest separation performance while suppressing both the EOF and the undesirable polymer-dye-DNA interactions can be identified and placed into use.

In the drawings and specification there has been set forth a preferred embodiment of the invention, and although specific terms have been employed, they are used in a generic and descriptive sense only and not for purposes of limitation, the scope of the invention being defined in the claims.

That which is claimed is:

1. An electrophoretic screening instrument comprising:
a plurality of capillaries;
a loading station at a first end of each said capillary for loading said capillary with a flowable separation medium independently from the remainder of said capillaries;
a sample station for adding a charged sample into each said capillary;
electrodes for applying a potential difference across each capillary to thereby drive the sample through the separation medium; and
a detector system for concurrently determining a property of each sample (or of a component thereof) in each capillary.

2. An electrophoretic instrument according to claim 1 wherein said sample station is at the opposite end of each said capillary from said loading station.

3. An electrophoretic instrument according to claim 1 wherein each of said capillaries is loaded with a different separation medium.

4. An electrophoretic instrument according to claim 1 comprising:
at least four capillaries; and
a different separation media in each capillary

5. An electrophoretic instrument according to claim 1 comprising:
at least eight capillaries; and
a different separation media in each capillary

6. An electrophoretic instrument according to claim 1 comprising:
at least twenty-four capillaries; and
a different separation media in each capillary

7. An electrophoretic instrument according to claim 1 wherein said detector system comprises a source for directing electromagnetic radiation onto said capillaries; and
wherein said detector measures the effect of the electromagnetic radiation on the samples in said capillaries.

8. An electrophoretic instrument according to claim 7 wherein said source comprises a laser.

9. An electrophoretic instrument according to claim 8 wherein said detector measures the fluorescence generated by the samples when illuminated by said laser.

10. An electrophoretic instrument according to claim 9 wherein said detector comprises a parallel detector.

11. An electrophoretic instrument according to claim 9 wherein said detector comprises a scanning detector.

12. An electrophoretic instrument according to claim 1 wherein said separation medium loading means comprises a plurality of syringes and configured with each said syringe corresponding to one of said capillaries.

13. An electrophoretic instrument according to claim 2 wherein said sample station comprises a staging assembly for adding a sample into each capillary and thereafter positioning said opposite end of each capillary in a buffer solution.

14. An electrophoretic instrument according to claim 1 comprising a buffer reservoir at said first end of each said capillary

15. A loading manifold for capillary electrophoresis and screening, said manifold comprising:
a body;
a plurality of separate flowpaths in said body for independently loading a plurality of capillaries with a flowable separation media, said plurality of flowpaths including
a plurality of fluid inlets in said body;
a corresponding plurality of fluid outlets in said body, each of which is in fluid communication with a corresponding inlet;
a corresponding plurality of reservoirs in said body, each of which is in independent fluid communication with a corresponding flowpath; and
an electrode port in communication with said reservoirs.

16. A loading manifold according to claim 15 comprising a plurality of electrode ports in said body, each of which is in communication with one of said reservoirs.

17. A loading manifold according to claim 16 comprising a plurality of electrodes with each electrode corresponding to one of said electrode ports.

18. A loading manifold according to claim 17 wherein each electrode is controlled independently of said other electrodes.

19. A loading manifold according to claim 15 and further comprising a plurality of valves, each of which is operable to isolate a respective reservoir from its corresponding inlet or outlet.

20. A loading station comprising:
the loading manifold according to claim 15; and
a plurality of fluid sources, each of which is in fluid communication with one of said inlets for loading capillaries in communication with said outlets with the contents of the respective fluid sources.

21. A loading station according to claim 20 wherein said fluid sources comprises syringes.

22. A loading station according to claim 20 wherein said outlets are in fluid communication with said capillaries.

23. A loading manifold according to claim 20 and further comprising means for concurrently delivering the contents of said syringes into said inlets.

24. A loading manifold according to claim 23 wherein:
said inlets are arranged in a single row
said syringes engage said manifold body at said inlets in a corresponding single row; and
said concurrently delivering means comprises
a motor operatively connected to the plungers of said syringes for driving said plungers to deliver a fluid to said inlets.

25. A loading manifold according to claim 24 wherein said plungers are fixed to a plate and said motor drives said plate.

26. An electrophoretic screening instrument comprising:
a loading station having four or more independent flowpaths, each of which comprises a fluid inlet and a corresponding fluid outlet, said inlet being in fluid communication with said outlet to thereby permit fluid flow between said inlet and said corresponding outlet;
four or more corresponding loading syringes, each of which is in fluid communication with one of said fluid inlets;
four or more corresponding capillaries, each of which has a first end that is in fluid communication with one of said fluid outlets so that said capillaries can be individually loaded with the contents of a syringe through a flowpath of the loading station;
a sampling assembly in fluid communication with the opposite end of each said capillary for adding a sample to the opposite end of each said capillary;
circuitry for applying an electric field across each said capillary; and
a detection system for measuring a property of a sample in each capillary.

27. An instrument according to claim 26 and further comprising:
four or more reservoirs, each of which is in fluid communication limited to one of said flowpaths, and is adapted for carrying sufficient fluid electrolyte therein to maintain a substantially constant potential across said capillary in fluid communication with said reservoir when an electric field is applied; and
four or more corresponding electrode ports for providing an independent corresponding electrode to each said reservoir for applying an electric field.

28. An instrument according to claim 27 comprising:
four or more valves for individually isolating a reservoir from its corresponding flowpath to thereby limit fluid flow to its respective first passageway.

29. An instrument according to claim 26 wherein said sampling assembly comprises a staging assembly for moving samples in three dimensions.

30. An instrument according to claim 26 wherein said detection system comprises a laser for exciting the samples and a detector for capturing the emission from the excited samples.

31. An instrument according to claim 30 wherein said laser is an argon ion laser and said detector is a charge coupled display camera that measures the fluorescence from the excited samples.

32. An instrument according to claim 26 comprising a plurality of said loading stations, with four or more corresponding syringes being associated with each of said loading stations.

33. An instrument according to claim 32 wherein each of said four or more capillaries pass a common detector for simultaneous detection.

34. A method of screening separation media for performance in capillary electrophoresis, the method comprising:
loading each of a plurality of capillaries from one corresponding end of each with a respective plurality of at least two different separation media and with one media per capillary;
introducing a sample into each capillary;
advancing the samples through the capillaries under an applied electric field;
measuring a property of the samples or components thereof as they advance through the capillaries;
using the measured properties to identify one or more preferred sets of separation media; and
wherein at least one of the steps of loading or advancing are carried out simultaneously over the plurality of capillaries.

35. A method according to claim 34 wherein the step of loading the capillaries with separation media comprises loading the capillaries with polymeric separation media.

36. A screening method according to claim 34 wherein the step of loading the capillaries comprises loading the capillaries with compositions selected from the group consisting of separation polymers, wall-coating polymers, buffer solutions, and combinations thereof.

37. A screening method according to claim 34 wherein the step of loading the capillaries comprises loading the capillaries from a library of candidate separation media.

38. A screening method according to claim 34 comprising loading each capillary with the same separation polymer and loading each capillary with a different wall-coating polymer.

39. A screening method according to claim 34 comprising loading each capillary with the same wall-coating polymer and loading each capillary with a different separation polymer.

40. A screening method according to claim 34 comprising loading some but not all of the capillaries with the same separation polymer.

41. A screening method according to claim 34 comprising loading some but not all of the capillaries with the same wall-coating polymer.

42. A method of capillary electrophoresis comprising:
identifying a preferred set of separation media using the method of claim 28; and thereafter
conducting capillary electrophoretic separation of desired samples using the identified preferred set of separation media.

43. A method according to claim 34 wherein the advancing step further comprises applying different electric fields across at least two different capillaries.

44. A capillary electrophoresis method according to claim 43 comprising separation of one or more members of the group consisting of DNA, DNA fragments, other nucleotides or oligonucleotides, polysaccharides, polyelectrolytes, proteins, small organic molecules, nonbiological electrolytes, and combinations thereof.

45. A method of screening polymers for electroosmotic flow comprising:
advancing probe compositions through at least two different electrophoresis capillaries that contain polymer compositions, with the contents of the capillaries differing from one another by the probe composition advanced therethrough or by the polymer composition contained therein or both;
measuring the migration time of at least one probe composition in each capillary;
loading each capillary with a selected separation polymer and a selected wall-coating polymer;
advancing the same probe composition through each respective capillary in the presence of the selected separation polymer and a selected wall-coating polymer;
measuring the migration time of each probe composition in the presence of the selected separation polymer and the selected wall-coating polymer; and
using the measured migration times to identify one or more preferred members of the group consisting of the probe compositions, the separation polymers, and the wall-coating polymers.

46. A capillary electrophoresis method comprising:
the screening method of claim 45 and thereafter;
carrying out a capillary electrophoresis separation on a sample using a selected combination of the identified preferred separation polymers and preferred wall coating polymers as at least a portion of the CE separation medium.

47. A screening method according to claim 45 wherein the advancing step comprises using the same separation polymer in each capillary.

48. A screening method according to claim 45 wherein the advancing step comprises using a different separation polymer in each capillary.

49. A screening method according to claim 45 wherein the advancing step comprises using the same dye in each capillary.

50. A screening method according to claim 45 wherein the advancing step comprises using a different dye in each capillary.

51. A screening method according to claim 45 wherein the advancing step comprises using the same wall-coating polymer in each capillary.

52. A screening method according to claim 45 wherein the advancing step comprises using a different wall-coating polymer in each capillary.

53. A screening method according to claim 45 wherein the advancing step comprises keeping one member of the group consisting of the dyes, the separation polymers and the wall-coating polymers the same in each capillary while varying the other two members of the group among the capillaries.

54. A screening method according to claim 45 wherein the advancing step comprises keeping two members of the group consisting of the dyes, the separation polymers and the wall-coating polymers the same in each capillary while varying the third member of the group among the capillaries.

55. A method of screening polymers for electroosmotic flow, the method comprising:
concurrently advancing a charged dye compound and a dye-labeled short oligonucleotide through an electrophoresis capillary that is filled with a separation polymer and a first candidate supplemental polymer;
measuring the respective migration times for the charged dye compound and the dye-labeled oligonucleotide;
repeating the advancing and measuring steps using the same charged dye compound and the same dye-labeled oligonucleotide but with at least a second candidate supplemental polymer; and
identifying the first or second candidate supplemental polymer as preferred over the other on the basis of the absolute and comparative migration times of the charged dye compound and the dye-labeled oligonucleotide in each of the advancing and measuring steps.

56. A method according to claim 55 wherein the advancing and measuring steps for the second candidate polymer are carried out simultaneously with the advancing and measuring step for the first candidate polymer.

57. A method according to claim 55 wherein the advancing and measuring steps for the second candidate polymer are carried out sequentially to the advancing and measuring step for the first candidate polymer.

58. A method according to claim 55 wherein the candidate supplemental polymers are wall-coating polymers.

59. A method of capillary electrophoresis comprising:
identifying the preferred candidate supplemental polymer according to the method of claim 55; and thereafter
adding the preferred candidate supplemental polymer to another electrophoresis capillary and carrying out an electrophoretic separation in the presence of the identified preferred supplemental polymer.

60. A capillary electrophoresis method according to claim 59 comprising electrophoretic separation of DNA, DNA fragments, other nucleotides or oligonucleotides, polysaccharides, polyelectrolytes, proteins, small organic molecules, nonbiological electrolytes, and combinations thereof.

61. A screening method according to claim 55 wherein the step of repeating the running and measuring steps comprises repeating the steps simultaneously.

62. A screening method according to claim 55 wherein the step of repeating the running and measuring steps comprises serially repeating the steps.

63. A screening method according to claim 55 wherein the electrophoretic separation in the presence of the identified preferred polymer comprises DNA sequencing.

64. A method of screening polymers for electroosmotic flow, the method comprising:
concurrently advancing a charged dye compound and a dye-labeled short oligonucleotide through a plurality of electrophoresis capillaries, each of which is filled with a separation polymer and a supplemental polymer;
measuring the respective migration times in each capillary for the dye compound and the dye-labeled oligonucleotide; and
identifying preferred members selected from the group consisting of the separation polymers and the supplemental polymers on the basis of the absolute and comparative migration times of the charged dye compounds and the dye-labeled oligonucleotides in each capillary.

65. A method of capillary electrophoresis comprising:
identifying a preferred member of the group consisting of separation polymers and wall coating polymers and combinations thereof according to the method of claim 64; and thereafter
adding the preferred member to another electrophoresis capillary and carrying out an electrophoretic separation in the presence of the identified preferred member.

66. A screening method according to claim 64 comprising filling each capillary with the same separation polymer.

67. A screening method according to claim 64 comprising filling each capillary with a different separation polymer.

68. A screening method according to claim 64 comprising filling some but not all the capillaries with the same separation polymer.

69. A screening method according to claim 64 comprising filling each capillary with the same wall-coating polymer.

70. A screening method according to claim 64 comprising filling each capillary with a different wall-coating polymer.

71. A screening method according to claim 64 comprising filling some but not all the capillaries with the same wall-coating polymer.

72. A screening method according to claim 64 wherein the step of concurrently running the dye and the dye-labeled oligonucleotide through the capillaries comprises running a library of selected oligonucleotides with one member of the library in one respective capillary.
